(19) United States
(12) Patent Application Publication
(10) Pub. No.: US 2010/0286944 A1
(43) Pub. Date: Nov. 11, 2010

(54) METHOD FOR IDENTIFYING SENSORS ON A BUS BY A CONTROL UNIT, AS WELL AS A CONTROL UNIT AND A SENSOR FOR DOING THIS

(76) Inventors: Eckart REIHLEN, Stuttgart (DE); Alex Grossmann, Leonberg (DE); Bernhard Opitz, Leonberg (DE); Johannes Grabis, Renningen (DE); Marc Rosenland, Hohenhaslach (DE)

Correspondence Address: KENYON & KENYON LLP, ONE BROADWAY, NEW YORK, NY, 10004, US

(21) Appl. No.: 12/764,599

(22) Filed: Apr. 21, 2010

(30) Foreign Application Priority Data
Apr. 29, 2009 (DE) 10 2009 002 708.4

(51) Int. Cl. G06F 19/00

(52) U.S. Cl. 702/122

(57) ABSTRACT

A method for identifying sensors on a bus by a control unit, as well as a control unit and a sensor for doing this. The sensors, in this instance, send physical useful data to the control unit as the basis for the control of a function. Furthermore, the physical useful data are compared to one another and/or to specified expected values, and the identification of the sensors by the control unit takes place with the aid of the comparison and based on characteristic differences in the physical useful data for the sensors.

### RELATED APPLICATION INFORMATION

The present application claims priority to and the benefit of German patent application no. 10 2009 002 708.4, which was filed in Germany on Apr. 29, 2009, the disclosure of which is incorporated herein by reference.

### FIELD OF THE INVENTION

The present invention relates to a method for identifying sensors on a bus by a control unit, as well as a control unit and a sensor for doing this.

### BACKGROUND INFORMATION

Up to now, bus systems for connecting sensors for applications in a passenger car are still rather unusual. However, in the future more such systems will be used, since they offer numerous advantages. In order for a sensor to be able to be used in such a system, it must be clearly identifiable, for otherwise the control unit is not in a position to distinguish which signal comes from which sensor. In principle, it is possible to define a sequence (first sensor in the bus, second sensor, . . . ) via the topology of the bus, but such a daisy chain configuration would lead to costly wiring which is just what a bus system is intended to avoid. An advantageous star topology is thus not possible. In the case of a plurality of sensors, that are identical or of the same type, on a bus, logically costly (poka-yoke) or technically costly (wiring) design approaches have to be used to make possible a clear identification.

In related art DE10023355A1 it is described that, on the same bus, identical acceleration sensors used at various places are identified by the respective signal they send to a control unit, the signal coming about because, in an addressing phase, for the purpose of the addressing, mechanical vibrations are generated in the vicinity of each identical acceleration sensor.

### SUMMARY OF THE INVENTION

The exemplary embodiments and/or exemplary methods of the present invention relates to a method for identifying sensors on a bus by a control unit, as well as a control unit and a sensor for doing this. Because of the exemplary embodiments and/or exemplary methods of the present invention, it becomes possible to identify sensors, especially sensors of the same type or identical sensors, on a common bus, based on the characteristics of their physical useful data, that is, without a costly logical system being required beforehand to characterize the position of the respective sensor. It is also not necessary, especially for the purpose of addressing, to generate signals so as thereby to achieve identification of the sensors. This therefore describes a particularly simple and thus cost-effective identification method for sensors on a bus.

Further advantages and improvements are derived from the further features also described herein.

In one advantageous embodiment, the control unit compares the physical useful data to specified expected values and identifies the sensors with the aid of this comparison. This embodiment has the advantage that control units normally have means which may also be suitable for a use according to the exemplary embodiments and/or exemplary methods of the present invention, such as a memory or access to a memory, in order to store the expected values, and means for carrying out a comparison of physical useful data to one another and/or to the expected values, for instance, a computing unit. No additional expenditure, or only a slight one is thereby required for implementing the exemplary embodiments and/or exemplary methods of the present invention in this design, using components already present.

A further advantageous embodiment relates to each sensor comparing the physical useful date to specified expected values, to the transmitting of the physical useful data to the control unit takes place based on the comparison in a characteristic time sequence, and to the control unit identifying the sensors with the aid of the characteristic time sequence. This advantageously achieves that the comparison according to the exemplary embodiments and/or exemplary methods of the present invention is shifted to the sensors, and because of the time sequence of the sensor messages, possible traffic jam problems or collision problems are avoided. This specific embodiment may be particularly advantageous, for instance, when the sensors for the planned application purpose normally have means for implementing the procedure according to the present invention without an additional upgrade, or at least at low additional expenditure.

It may also be expedient, depending on the process, at certain points in time to draw upon the value of the physical useful data of the sensors for comparison to one another and/or to the specified expected value of the physical useful data, or to carry out a comparison of combinations of these. By this procedure, it is not only possible to identify the sensors based on characteristic values of the physical useful data, but also based on characteristic curves of these, whereby a very flexible method may be implemented.

The certain points in time at which the comparison of the physical useful data takes place may advantageously be specified by a state of the controlled function. Because of this, for one, the characteristic expected values for certain situations (specifically the certain states of the controlled function) may be stored, which makes possible a particularly unequivocal identification. Because of such a procedure, a comparison is possible of the physical data as a function of the functions controlled by the control unit, or at least registered by the control unit, or by the sensor. For another thing it may be advantageous, at certain points in time (for instance, at the start of a device) to trigger an identification, so that then (for example, at the start) an identification is clearly given.

In another advantageous exemplary embodiment, the certain points in time are established not by the controlled function, but by a loss of identification data. Therefore, in the case of identification loss (for example by EMC (electromagnetic compatibility) influences) it is possible to begin an immediately renewed identification, and thereby ensure an interference-free operation, even in such cases.

The invention introduced is particularly advantageous in the case of a plurality of identical sensors (for instance, only temperature sensors or only pressure sensors) or a plurality of identical sensors (e.g. identical temperature sensors or identical pressure sensors), since in these cases an identification or labeling of the position on the bus, of the respective sensor, beforehand is particularly costly according to the related art, and therefore the greatest effort and cost savings by the invention occur in such cases.

Exemplary embodiments of the present invention are shown in the drawings and explained in greater detail in the following description. The figures are merely examples and do not restrict the exemplary embodiments and/or exemplary methods of the present invention. In the drawings, reference numerals having two equal last numbers designate the same or similar elements.

### BRIEF DESCRIPTION OF THE DRAWINGS

FIG. 1 shows an exemplary embodiment of pressure sensors in an intake manifold in a motor vehicle.

FIG. 2 shows an exemplary embodiment of temperature sensors in an exhaust branch in a motor vehicle.

### DETAILED DESCRIPTION

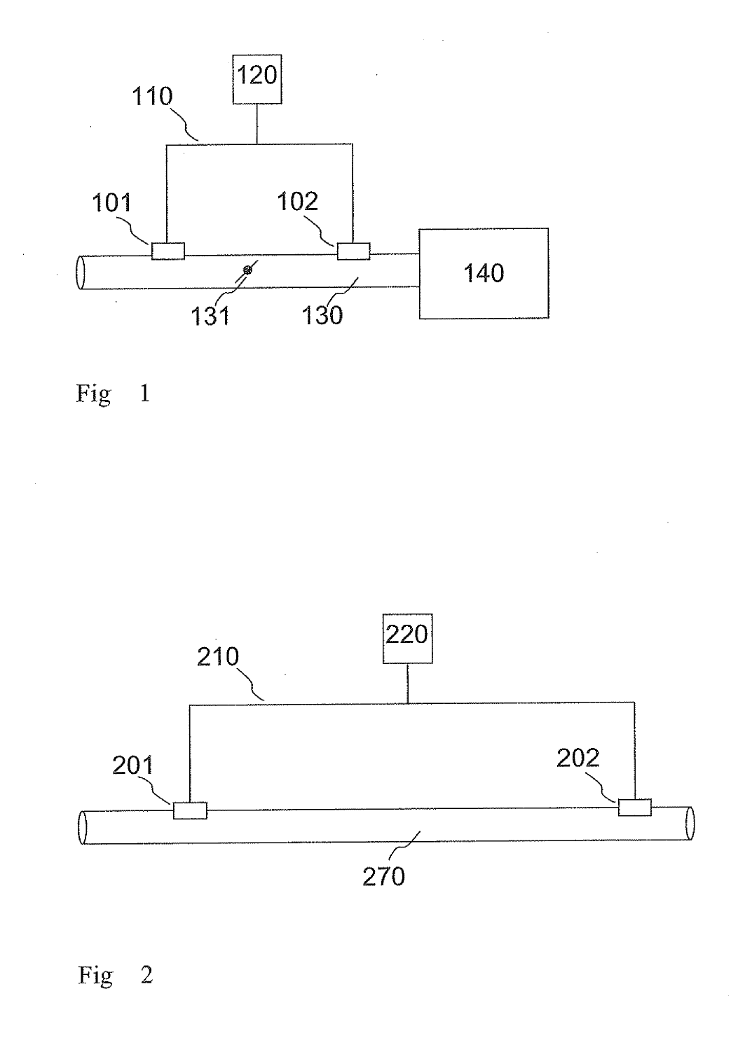

FIG. 1 shows an exemplary embodiment for the method according to the present invention, with the aid of pressure sensors on an intake manifold of an internal combustion engine having a turbocharger. Two identical pressure sensors 101 and 102 are used in this instance, which are connected to a control unit 120 via a star-shaped bus 110. Pressure sensors 101 and 102 are installed on intake manifold 130, pressure sensor 101 upstream of throttle valve 131 of intake manifold 130, pressure sensor 102 between throttle valve 131 and internal combustion engine 140. Consequently, pressure sensor 101 measures the pressure before throttle valve 131 (the boost pressure), and pressure sensor 102 measures the pressure between throttle valve 131 and internal combustion engine 140 (the intake manifold pressure). The pressure data of these measurements are communicated by pressure sensors 101 and 102 via bus 110 to control unit 120, control unit 120 controlling functions using these physical useful data, for instance, it has a share in controlling the engine of internal combustion engine 140.

Since in this exemplary embodiment the two pressure sensors 101 and 102 are identical, and are connected to control unit 120 via a bus line 110, a question arises regarding the addressing of pressure sensors 101 and 102 or the recognition of pressure sensors 101 and 102 by control unit 120. On this point, it is provided that the identification of sensors 101 and 102 at bus 110 should be made possible by control unit 120 with the aid of the physical useful data, in this case the pressure data. For this purpose, control unit 120 compares the useful data received, that is, the pressure data, in this case, which are needed by control unit 120 for the control, of pressure sensors 101 and 102 to specified expected values, and with the aid of this comparison it identifies the positions of pressure sensors 101 and 102 at intake manifold 130.

During the start of internal combustion engine 140 at a typically largely closed throttle valve 131, sensors 101 and 102 may be identified, for example, with the aid of the characteristics of the pressure data for boost pressure and intake manifold pressure. The pressure in intake manifold 130 between throttle valve 131 and internal combustion engine 140 drops off rapidly, and the pressure before throttle valve 131 remains nearly constant. That being the case, an assignment of the respective sensor signal is possible, although the two sensors 101 and 102 may possibly differ only by a different serial number and are otherwise identical.

In this example, therefore, as the expected values for the comparison using the physical useful data (pressure values), the pressures to be expected and the time curves of the pressures to be expected at the positions “upstream of throttle valve 131” and “between throttle valve 131 and internal combustion engine 140” are stored in control unit 120. By the comparison of the received pressure values having these expected values, particularly at certain times that are specified by the controlled function (in this case, the engine control), pressure sensors 101 is able to be assigned to the position “upstream of throttle valve 131”, and pressure sensors 102 to the position “between throttle valve 131 and internal combustion engine 140”, and a corresponding identification or addressing is able to be made by control unit 120.

As a further exemplary embodiment, in which an identification according to the present invention is advantageous, FIG. 2 shows the use of temperature sensors in the exhaust branch of a motor vehicle. Two identical temperature sensors are designated as 201 and 202, in this instance, which are used in exhaust branch 270 for temperature measurement, and are connected to a control unit 220 via a bus 210. The temperature data are transmitted by sensors 201 and 202 via bus line 210 to control unit 220, which controls a function in the motor vehicle, for instance, it takes a part in engine control. By such a control of sensors 201 and 202 in exhaust branch 270, using a bus 20, for instance, a digital bus system PSI5, savings come about in cable length, number of plugs and installation space. In the present exemplary embodiment, let us say, for instance, in the plug of the temperature sensor an ASIC is installed, which converts the typically analog resistance signal or voltage signal of the temperature sensors into a digital signal. In this case, the signal line to the control unit is made up, for instance, of two wires for the energy supply of the ASIC and the signal transmission using current modulation.

As was described in FIG. 1 for the case of pressure sensors 101 and 102, it is also advantageous, in the example in FIG. 2, for the two temperature sensors 201 and 202 in exhaust branch 270 to use identical sensors, in order to save (above all logistical) expenditure. The different temperature sensors 201 and 202 along exhaust branch 270 must, however, be able to be again unequivocally assigned by bus 220. The addressing of temperature sensors 201 and 202 is possible by a plausibility check of the temperature signals, especially by a comparison of the temperature signals to the expected values, as a kind of self-arbitration, so to speak.

Upon a cold start in the engine, for instance, the installation location in exhaust branch 270 is detected with the aid of the reaching of a certain temperature threshold that is dependent on the application. Only when the temperature threshold is exceeded does the ASIC switch to release the respective sensor 201 or 202, and the address comparison to control unit 220 takes place. For a hot start having an unspecified temperature distribution along the exhaust branch (e.g. a hot start after a Diesel particle filter regeneration that has just taken place), the temperature curve over time is drawn upon as the second criterion, for instance. For this, one may draw, for instance, upon the exceeding of a relative temperature threshold with reference to the initial temperature at the engine start, for the address assignment. Independently of the temperature distribution along exhaust gas pipe 270 for the standing vehicle at a hot start, the reincrease by, for example, 20 K, that is, the point in time of the exceeding of the threshold (T before engine start+20K) will take place in the order along exhaust branch 270. As was described for the cold start scenario above, after exceeding the threshold (that is variable depending on the initial conditions), sensor 201 or 202 sends a signal and an address is assigned to it (first sensor is identified by Pos. 1, second sensor by Pos. 2, and so on along exhaust branch 270). Because of the relative lag of the temperature curve in exhaust branch 270 (time for temperature jumps of the order of magnitude of a few seconds) in comparison to the time required for the address assignment by control unit 220 (order of magnitude of a few milliseconds) it is ensured that there will be no address conflicts in the sensor assignment.

In the example shown in FIG. 2, bus 210 as described may be a PSI5 bus. This PSI5 bus is based on the idea that, within a message frame initiated by a synchronization pulse that is emitted by control unit 220 (master), each sensor 201, 202 (slaves) is assigned its own time slot for its messages to control unit 220. Since these messages are coded via current modulation, only control unit 220 (the master) is able to receive its content. Before the self-arbitration, the time slots assigned to them are not known to sensors 201, 202. Therefore, sensors 201 and 202 first transmit, as of the time of the reaching of the temperature criterion described above, on an additional time slot (e.g. the first), which is only reserved for the arbitration, and which remains unused after the termination of same. Control unit 220 acknowledges such measuring data on the arbitration channel (or rather the arbitration time slot) using a channel assignment via the control unit-to-sensor channel, which is implemented, according to the specification of the PSI5 (option for bidirectional PSI5 variants), by the targeted suppression of individual synchronization pulses. After EMC interferences, which reset only individual sensors 201 or 202 of the bus, control unit 220 is able to detect the situation with the aid of the absence of messages on certain assigned time slots and messages on the arbitration channel, and react accordingly using the time slot assignments. The main condition for the success of the embodiment of the method, according to the present invention, described in FIG. 2, for the case of more than one sensor affected by the EMC interference is that, for instance, after such an EMC interference, characteristic temperature values and characteristic temperature curves over time are also present or are also triggered.

In the exemplary embodiment shown schematically in FIG. 2, the comparison in control unit 220 takes place, not to expected values for the temperature values of temperature sensors 201 and 202 or to the curve over time of the temperature values of temperature sensors 201 and 202, but rather, what is decisive is the sequence over time at which the temperature values reach control unit 220. This sequence is in turn a function of the temperature values registered in sensors 201 and 202 or of the curves over time of the temperature values registered in sensor 202 and 202. For example, because of the exceeding of certain threshold values or because of certain value curves, first one of sensors 201 and 202 and then the other of sensors 201 and 202 is switched free for a bus communication via bus 210. Control unit 220 now has stored expected values for this time sequence of the incoming communication by sensors 201 and 202, and is able to undertake the addressing of sensors 201 and 202 by the comparison of the time sequence of the incoming sensor data to the expected time sequence.

Thus, in this case again, the identification of sensors 201 and 202 is implemented by a comparison of the physical useful data (in this case, the temperature data required by control unit 220 for the control) to specified expected values. The comparative values, in this instance, may relate to the value of the physical data, their time sequence or both. By contrast to the exemplary embodiment in FIG. 1, this comparison according to the exemplary embodiments and/or exemplary methods of the present invention in this example does not take place by control unit 220 but by sensors 201 and 202. Control unit 220 then identifies sensors 201 and 202 based on the time sequence of the bus signal of sensors 201 and 202 resulting from it.

There are various possibilities for the times for the comparisons according to the exemplary embodiments and/or exemplary methods of the present invention. In the description of FIG. 2, for example, for the case of a passenger car, above all engine starting times (cold start and hot start) are named. But even in the case of necessary renewed identification in the case of lost identification data (EMC influences) or at certain other times which may be determined with the aid of the controlled function, the comparison according to the exemplary embodiments and/or exemplary methods of the present invention is able to be carried out.

This is particularly the case if at these times certain characteristic values or value curves are to be expected, or when the expected values of the sensor data pertaining to these times, or of the sensor data curves over time are stored in the control unit for comparison. Because of such a procedure, a comparison is thus possible of the physical data as a function of the functions controlled by the control unit or at least registered by the control unit or by the sensor. Alternatively, one may also carry out a continuous comparison of the physical useful data to the expected values, in order to verify constantly an identification that has taken place.

In the exemplary embodiments it was described that the comparison of the physical useful data of the sensors takes place to specified expected values, that are stored, for instance, in the control unit or the sensors. Additionally or alternatively it may also be advantageous to compare the physical useful data of the various sensors to one another, in order to achieve an identification thereby. For instance, with the aid of the embodiment having pressure sensors analogous to FIG. 1: At the time of a certain throttle valve position, the comparison of the physical data of sensor 101 to the physical data of sensor 102 may take place, and by such a comparison for the point in time of this throttle valve position it may be clearly established which sensor is to be assigned to which position at the intake manifold, since it is clear, for example, from the throttle valve position which sensor will register the higher pressure at which position.

An identification according to the exemplary embodiments and/or exemplary methods of the present invention is naturally also possible for more than two sensors, and is particularly advantageous especially for larger numbers of sensors. Also, in the exemplary embodiments, only identical sensors were used in exemplary fashion. The method is also conceivable, however, in order to identify not identical, but only same types of sensors, such as only temperature sensors. In addition, the use of different sensors, such as pressure sensors and temperature sensors, is also imaginable, as long as these have characteristic and distinguishable values or value curves, and these are specified for a comparison.

Examples of application for identical sensors on a bus are intake manifold sensor and boost pressure sensor (FIG. 1), two intake manifold sensors for an engine having several banks and separate air guidance (two throttle valves that are controlled differently), two boost pressure sensors in an engine having several banks and several turbochargers, as well as separate turbocharger control (test functionality having different control of the turbochargers (waste gate, variable turbine geometry VTG)), intake air temperature sensors and engine temperature sensor, two temperature sensors on the exhaust branch (FIG. 2) and pressure sensors in the case of two throttle valves.

In both examples (description for FIG. 1 and description for FIG. 2), the identification of the sensors takes place based on the characteristic value or based on the characteristic curve over time of the physical useful data. In comparison to the related art, neither do identical sensors have to be provided with position statements by costly logistics, nor do signals or data have to be generated especially for the identification of the sensors.

What is claimed is:

1. A method for identifying sensors on a bus by using a control unit, the method comprising:
sending, using at least one first sensor and one second sensor, physical useful data to the control unit via the bus, the physical useful data being evaluated by the control unit for the control of a function;
comparing the physical useful data of the first sensor and of the second sensor to at least one of (i) one another and (ii) specified expected values; and
identifying the first sensor and the second sensor by using the control unit with the aid of the comparison and based on characteristic differences in the physical useful data of the first sensor and the second sensor.

2. The method of claim 1, wherein the control unit compares the physical useful data of the first sensor and of the second sensor to at least one of (i) one another and (ii) specified expected values, and wherein the control unit identifies the first sensor and the second sensor with the aid of the comparison of the physical useful data to the specified expected values.

3. The method of claim 1, wherein at least the first sensor and the second sensor compare the physical useful data to the specified expected values, wherein the sending of the physical useful data to the control unit takes place based on the comparison in a characteristic time sequence, and the control unit identifies the first sensor and the second sensor with the aid of the characteristic time sequence.

4. The method of claim 1, wherein the comparison of a value of the physical useful data takes place at certain points in time.

5. The method of claim 1, wherein the comparison of a curve over time of a value of the physical useful data takes place at certain points in time.

6. The method of claim 4, wherein the certain points in time are determined by states of the controlled function.

7. The method of claim 4, wherein the certain points in time are determined by a loss of identification data.

8. The method of claim 1, wherein the first sensor and the second sensor are sensors that are at least one of the same type and that are identical.

9. A control unit, comprising:
a receiving arrangement to receive physical useful data via a bus from at least one first sensor and one second sensor;
an evaluating arrangement to evaluate the physical useful data for the control of a function; and
an identifying arrangement to identify the first sensor and the second sensor with the aid of a comparison of the physical useful data of the first sensor and of the second sensor to at least one of one another and specified expected values and based on characteristic differences in the physical useful data for the first sensor and the second sensor.

10. The control unit of claim 9, wherein the control unit includes a comparing arrangement to compare the physical useful data of the first sensor and of the second sensor (102) to at least one of (i) one another and (ii) specified expected values.

11. A sensor to send physical useful data to a control unit via a bus, the physical useful data being evaluated by the control unit for the control of a function, comprising:
a comparing arrangement to compare the physical useful data to specified expected values, so as to provide a comparison; and
a control arrangement to allow the sending of the physical useful data to the control unit to take place at a point in time that is determined by the comparison.
